(19) United States
(12) Patent Application Publication
(10) Pub. No.: US 2004/0205059 A1
(43) Pub. Date: Oct. 14, 2004

(54) Information searching method, information search system, and search server

(76) Inventors: Shingo Nishioka, Kawagoe (JP); Yoshiki Niwa, Hatoyama (JP); Osamu Imaichi, Wako (JP)

Correspondence Address: Mattingly, Stanger & Malur, P.C., Suite 370, 1800 Diagonal Road, Alexandria, VA, 22314, US

(21) Appl. No.: 10/790,062

(22) Filed: Mar. 2, 2004

(30) Foreign Application Priority Data
Apr. 9, 2003 (JP) 2003-104771

(51) Int. Cl. G06F 7/00

(52) U.S. Cl. 707/3

(57) ABSTRACT

An information search system includes a similarity calculating block for forming a summary word list as a summary of a search request and calculating a similarity between the summary word list and a search target document and a restricting condition examining block for examining a restricting condition of the search target document and applies these two blocks in this order or its opposite order, thereby the system can search for documents which satisfy the restricting condition and are similar to the search request examining restricting condition upon execution of associative search yields much higher efficiency than applying them sequentially.

### BACKGROUND OF THE INVENTION

1. Field of the Invention

The invention relates to an information searching method, an information search system, and a searching server in a document search.

2. Description of the Related Art

As a document search system, hitherto, as disclosed in U.S. Pat. No. 6,457,004, a technique for searching for documents similar to a given document, sentence, or the like from a database has been known. Therefore, even in the case where a keyword which accurately expresses a target document cannot be come up with or the like, if at least one document close to the target document can be found, similar documents can be searched by designating such a document and making an association search.

An associative search system regarding a meta search in which a similar document type database and a keyword search type database are integrated has been disclosed in JP-A-2002-222210. According to such a system, when a document close to a target document cannot be found, a natural sentence of a certain length can be given as a search key. Therefore, such a system can be also regarded as a search system according to the natural sentence. Owing to such a function, by giving a part of a thesis or an abstract in progress, a patent in progress, or the like, similar theses or similar patents can be also searched. Such a search differs largely from the conventional keyword search.

The associative search system searches for documents similar to a document, a part of the document, a sentence, or the like which has been given from the database. Upon execution of the associative search, a frequency of a word, characters, or the like which appear in the given document or the like is often used, so that similar documents are searched by using the word or the like in the document as a hint. A statistical method is used for calculation of a similarity using the word or the like as a hint. Similarity between documents is usually calculated as the similarity between their word-frequency vectors.

In the associative search system, ordinarily, results are sequentially displayed from the result in which the similarity of the contents is statistically high, so that the user can selectively and sequentially browse the search results from the result in which likelihood of the similarity is high. However, although the documents which are statistically similar are searched, since the user does not understand the contents of the document, it is extremely difficult to accurately search the documents in accordance with the intention of the user.

On the other hand, according to the searching methods which have conventionally and widely been used, that is, in the database search which is made by a DB inquiry language, the database search which is made by designating restricting conditions by a simple interface, and the database search which is made by designating an indispensable keyword or a taboo keyword, unlike the associative search, if the searching intention lies within an expressible range, the intention of the user can be accurately reflected. According to those conventional searching methods, however, as displaying order of the search results, they have to be displayed in specific order depending on the database or, they have to be aligned on the basis of a value of a certain specific key designated by the user.

That is, hitherto, the user can use only one of those searching means.

### SUMMARY OF THE INVENTION

It is, therefore, an object of the invention that when an associative search is made, in addition to document or sentences as search request, restricting conditions are given and documents which satisfy the restricting conditions and are similar to the documents or sentences of the search request are searched. By this method, the associative search to which the intention of the user is more accurately reflected can be made and the search can be more efficiently made.

An associative search system of the invention comprises: a user interface for making an associative search; an association calculating server; and a network apparatus which mediates communication between them.

The user interface comprises: means for designating a document DB as a target of the associative search; means for inputting a sentence serving as a searching request of the associative search; means for inputting restricting conditions which should be applied to the target of the associative search; a button to instruct the start of the associative search; and means for displaying a result of the associative search and designating documents serving as searching request of the associative search.

The association calculating server has a searching server program. This program comprises: an importance calculating block; a summary word candidate holding block; a similarity calculating block; a restricting condition examining block; and a search result candidate holding block, wherein with respect to a document DB serving as a search target, words appearing in each document (document-to-word index), a document to which each word belongs (word-to-document index, or inverted index), and meta data regarding each document (e.g. total number of words, member of different words) are preliminarily analyzed and can be used for the search.

To search for documents similar to a search request, the searching server forms summaries of the documents and/or sentences serving as searching request by using the importance calculating block and the summary word candidate holding block and sets them to a summary word list. Subsequently, by the similarity calculating block, documents similar to the summary word list are searched from the document DB. A similarity of each target document is compared with the similarity of the document of the smallest similarity held in the search result candidate holding block, thereby discriminating whether the document can become a candidate of the search results or not. In this case, whether the document satisfies the restricting conditions or not is further discriminated by the restricting condition examining block. If YES, by adding such a document into the search result candidate holding block, the documents which satisfy the restricting conditions and are similar to the search request are searched. In this manner, whether the document is adapted to the given restricting conditions or not is examined, document adapted to the restricting conditions is outputted as a search result.

As another method, to search the documents similar to the search request, the searching server forms the summaries of the documents and/or sentences serving as searching request by using the importance calculating block and the summary word candidate holding block and sets them to a summary word list. Subsequently, by the restricting condition examining block, the documents which satisfy the restriction are searched from the document DB. Thereafter, for each document satisfying the restriction, the similarity between the document and the summary word list is calculated. The calculated similarity is compared with the similarity of the document of the smallest similarity held in the search result candidate holding block, thereby discriminating whether the document can become a candidate of the search results or not. If YES, by adding such a document into the search result candidate holding block, the documents which satisfy the restricting conditions and are similar to the search request are searched. In this manner, whether the document is adapted to the given restricting conditions or not is examined. The document adapted to the restricting conditions is outputted as a search result.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a construction of an embodiment of the invention;

FIG. 2 is a constructional diagram in the case where data regarding a document DB is divided into two parts;

FIG. 3 is a constructional diagram in the case where a user interface and a searching server are made operative by same hardware;

FIG. 4 shows an example of the user interface;

FIG. 5 shows an example of a user interface having an associative search start button;

FIG. 6 is a table in which data to be collected every button has been disclosed;

FIG. 7 shows the data regarding the document DB;

FIG. 8 shows data (document-word) regarding the document DB;

FIG. 9 shows data (word-document) regarding the document DB;

FIG. 10 shows data (meta data) regarding the document DB;

FIG. 11 shows a searching server program;

FIG. 12 shows a procedure 1: operation of a searching server;

FIG. 13 shows a procedure 2: creation of a summary word list;

FIG. 14 shows a procedure 3: creation of the summary word list (main body);

FIG. 15 shows a procedure 4: creation of the summary word list (calculation of importance and updating of summary word candidate holding means);

FIG. 16 shows a procedure 5: related documents are searched using the summary word list;

FIG. 17 shows a procedure 6: the related documents are searched using the summary word list (main body);

FIG. 18 shows a procedure 7: the related documents are searched using the summary word list (another method);

FIG. 19 shows a procedure 8: the related documents are searched using the summary word list (another method, main body);

FIG. 20 shows a procedure 9: examination of restricting conditions and addition of documents to search result candidate holding means);

FIG. 21 shows a procedure 10: the examination of the restricting conditions and updating of the documents in the search result candidate holding means);

FIG. 22 shows a part of the data regarding the document DB, a first portion;

FIG. 23 shows the data (document-word) regarding the document DB, a first portion;

FIG. 24 shows the data regarding the document DB, a second portion;

FIG. 25 shows the data (word-document) regarding the document DB, a second portion;

FIG. 26 shows a procedure 11: a document set is summarized and a summary word list is formed (divisional edition);

FIG. 27 shows a procedure 12: two summary word lists are combined;

FIG. 28 shows a calculating equation of an upper limit e of a probability in which perfect summary/association result cannot be obtained;

FIG. 29 shows a dependence relation of the procedures; and

FIG. 30 shows an example of execution of the procedures.

### DETAILED DESCRIPTION OF THE EMBODIMENTS

### Embodiment 1

<System>

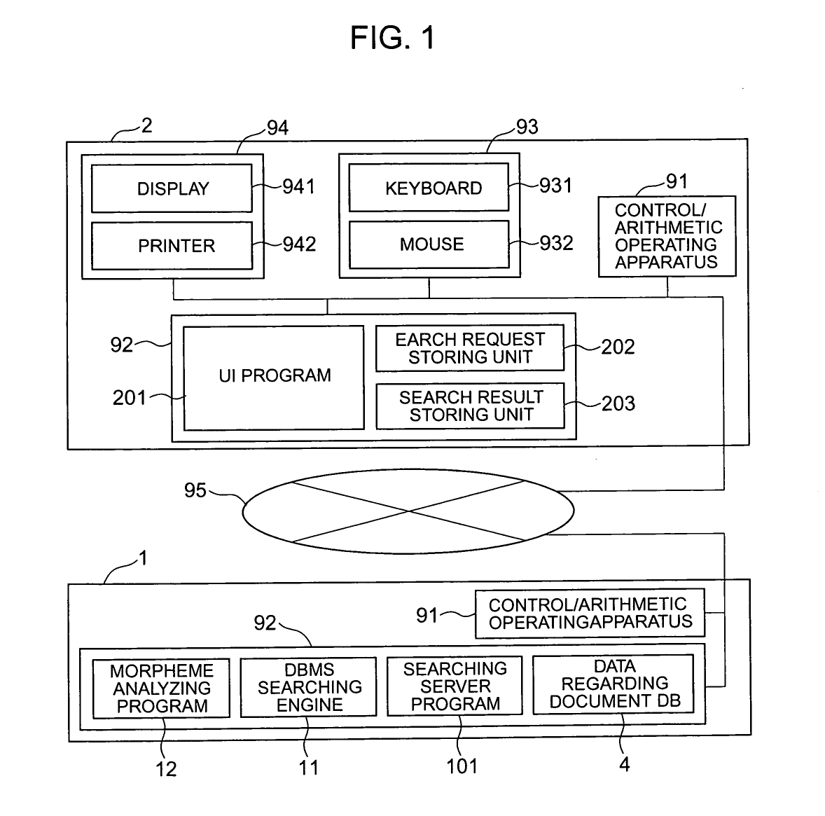

A whole system will be described hereinbelow. FIG. 1 is a schematic diagram showing a constructional example of the system to realize the invention. The system comprises: a user interface 2 which receives a search request from the user and displays a search result to the user; a searching server 1 for executing an associative search; and further, a communicating apparatus 95 which mediates communication between them. The communicating apparatus 95 connects computer hardware and enables communication between them.

The communicating apparatus has to be usable by the computer hardware and an operating system for controlling them. In the invention, connection by a dedicated line, a LAN, an Internet, or the like is used as a communicating apparatus.

The user interface 2 has: an output unit 94 comprising a display 941 and a printer 942; an input unit 93 comprising a keyboard 931 and a mouse 932; a processing unit 92 comprising a user interface program 201, a search request storing unit 202, and a search result storing unit 203; and a control/arithmetic operating apparatus 91 (or CPU). The searching server 1 has: the processing unit 92 comprising a morpheme analyzing program 12, a DBMS searching engine 11, a searching server program 101, and data 4 regarding a document DB; and the control/arithmetic operating apparatus 91.

The user interface 2 and the searching server 1 are constructed by computer hardware and software.

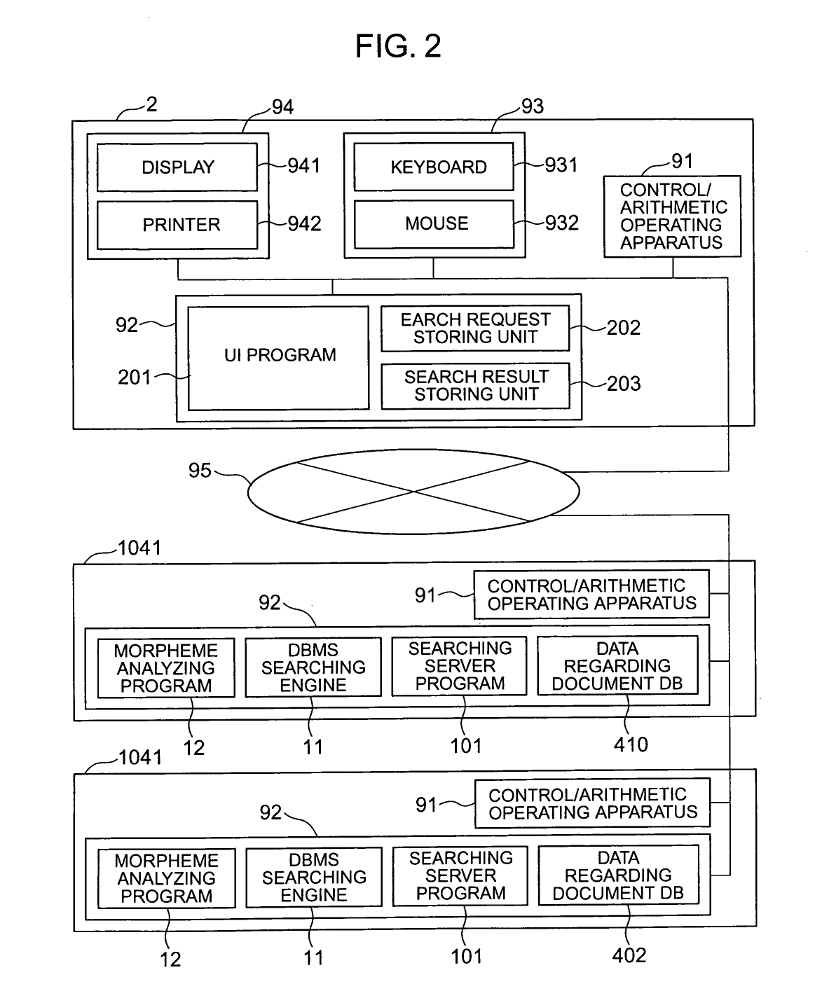

FIG. 2 is another example showing a system construction of the invention and shows an example in which two searching servers 1041 and 1041 are provided. The searching servers 1041 and 1041 have data 410 and 420 regarding the document DB. Since another construction is similar to that in FIG. 1, its description is omitted.

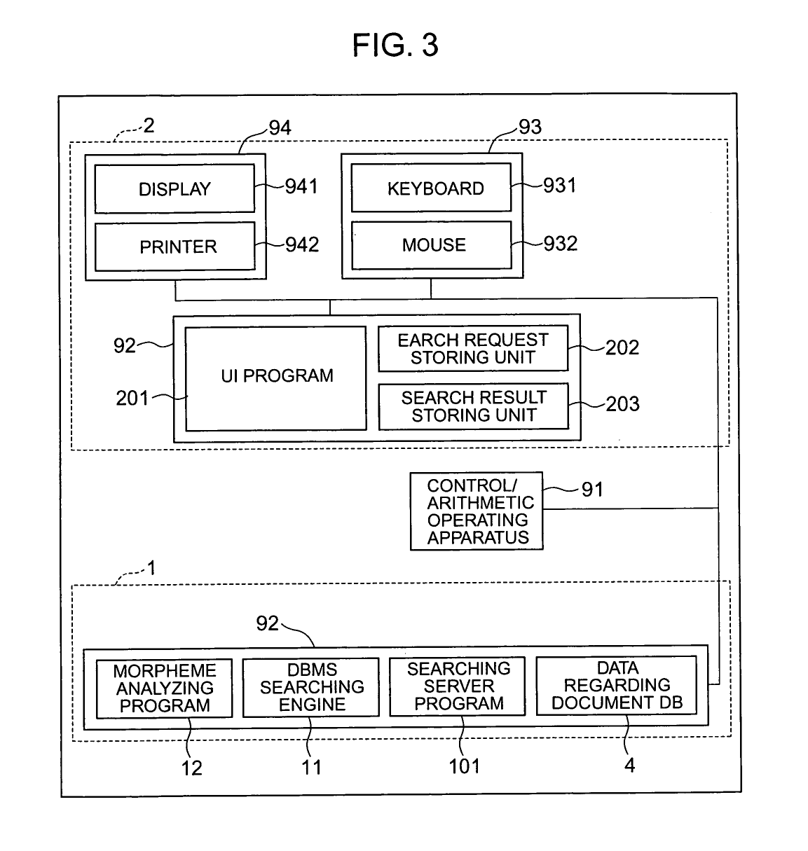

In the case where an operating system which is used as a platform enables a plurality of software to be executed on single hardware, as shown in FIG. 3, since both of the user interface 2 and the searching server 1 of the invention can operate without occupying the hardware, naturally, it will be understood that the user interface 2 and the searching server 1 can be made operative on single hardware. In this case, the user interface 2 and the searching server 1 communicate via the operating system and the communicating apparatus 95 which mediates communication between the two hardware becomes unnecessary. Since a construction shown in FIG. 3 is the same as that of FIG. 1, its description is omitted.

Since the user interface 2 and the searching server 1 communicate via the operating system irrespective of the presence or absence of use of the communicating apparatus and the operating system abstracts a communication path, in any case, since they execute the same operation, communication can be made. Therefore, the constructions of the software can be made identical in any case. Consequently, after that, with respect to the case where the programs of the user interface 2 and the searching server 1 and the like communicate, a difference of the constructions in which the communicating apparatus 95 is used or not is not mentioned and an expression “communication is made” is merely used unless otherwise specified.

<Searching Server>

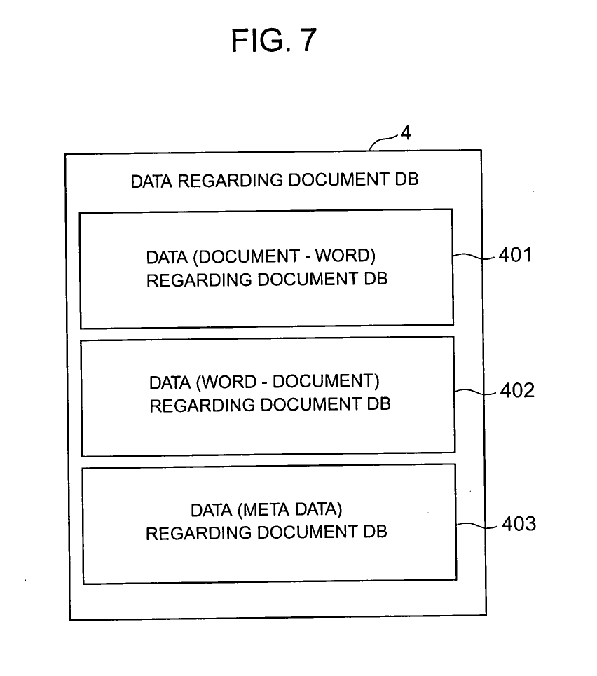

The searching server uses the data 4 regarding the document DB in order to execute the associative search of the document DB. As shown in FIG. 7, the data regarding the document DB comprises: data (document-word) 401 regarding the document DB; data (word-document) 402 regarding the document DB; and data (document-meta data) 403 regarding the document DB. As for the data (document-word) 401 regarding the document DB, with respect to all documents in the DB, sets each comprising an ID of a word appearing in the document and a frequency of appearance of the word in this document are collected as a list. This data is pre-computed (before searching). As for the data (word-document) 402 regarding the document DB, on the contrary to the data (document-word) 401 regarding the document DB, with respect to all words in the DB, sets each comprising an ID of the document including the word and a frequency of appearance of the word in this document are collected as a list. This data is pre-computed (before searching).

The data 402 can be easily formed by presuming a whole table of the data (document-word) 401 regarding the document DB as a matrix and forming its transposed matrix. The data (document-meta data) 403 regarding the document DB includes a title for displaying the search result by the user interface and a URL for displaying a main body of the search result. Those data is the same as that which is used in another ordinary search system and proper data has to be prepared for every document database.

If it is unnecessary to display the main body or the display of the main body can be executed only by the user interface by using the document ID or the like as a hint or the title can be displayed by likewise using the document ID or the like as a hint, it is unnecessary to form a part or all of this table. In this case, the searching server does not need to send the data extracted from the table to the user interface (which will be explained hereinlater).

The data (document-meta data) 403 regarding the document DB is pre-computed (before searching).

<User Interface>

The user interface will now be described. In the user interface, a portion which can be seen from the user comprises: a database selecting unit 211; an inquiry input unit 212; a restricting condition input unit 213; a search start button 214; and a search result display unit 215. There is also a case where it has a document association search start button 216 in dependence on the construction.

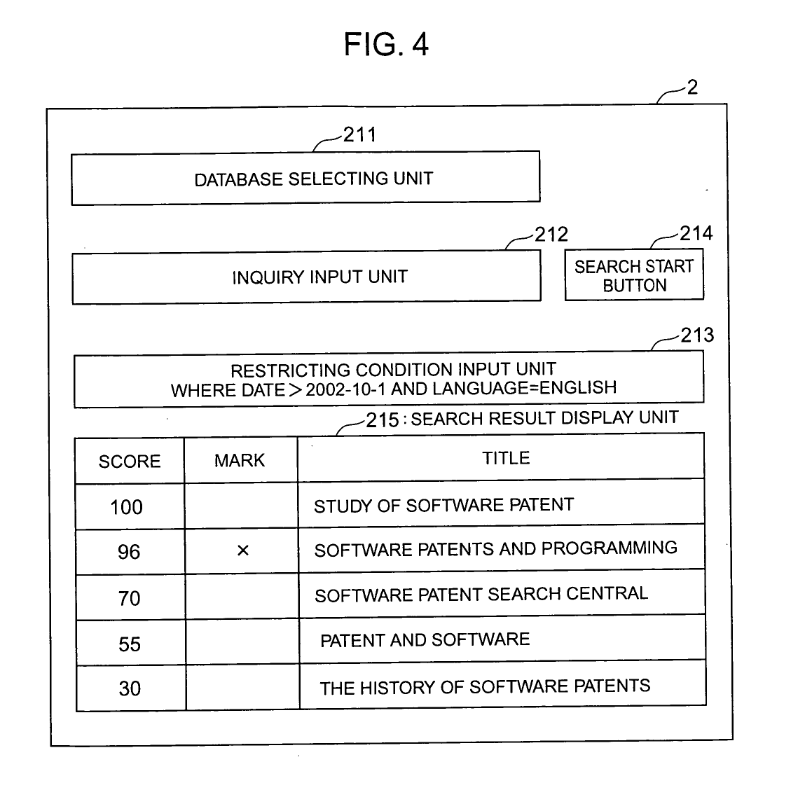

An example of the user interface is shown in FIG. 4. A name of the database as a search target is inputted to a database selecting unit 211. It is also possible to construct in such a manner that selection items are shown and by selecting the database as a search target, the database as a search target is transferred to the user interface. It can be realized by using standard parts in the platform used for installation.

A sentence, a word train, or the like serving as an associating source of the associative search can be inputted to an inquiry input unit 212. It can be realized by using standard parts in the platform for executing the user interface to which the sentence can be inputted.

A restricting condition input unit 213 is an input interface for inputting restricting conditions which are additionally designated upon associative search. It is installed by a different method in accordance with the types of restricting conditions to be supported.

For example, in the case of the installation in which a conditional clause of SQL can be used as a restricting condition, an ordinary text input interface, a structure editor by which a structure of the conditional clause of SQL can be parsed or highlight-displayed, or the like can be used. In the case of enabling an indispensable word or a taboo word to be used as a restricting condition, respective text input window are prepared in correspondence to indispensable or taboo. Another method is that in the case of the indispensable word, “+” and in the case of the taboo word, “−” is added to a position before the word and by referring to such a symbol added to the front position, whether the word is the indispensable word or the taboo word can be also discriminated. Also in the case of using a logical expression or the like, various interfaces such as text input interface, a structure editor for the logical expression, and the like can be used. In the invention, either a unit which has specially been installed or a unit which can be used as a standard in the system can be used as a restricting condition input unit.

A search start button 214 is realized by using standard parts in the platform which executes the user interface and can be easily installed.

A search result display unit 215 is used mainly to present the search result to the user. For each document, its title and the similarity to the search request, and the like are displayed. An instruction to display the main body can be made on/in the search result display unit 215. As another function of the search result display unit 215, a plurality of displayed documents are marked. The marks can be recognized by the user interface. The marked one or plural documents are handled as an associating source documents upon associative search. The search result display unit can be easily installed by using the standard parts called a list view or the like.

In the user interface, a portion which cannot be directly operated by the user comprises the user interface program 201, the search request storing unit 202, and the search result storing unit 203 (FIG. 1).

The user interface program 201 is a command and data to control the whole user interface. The search request storing unit 202 temporarily stores the data such as a search request input to the inquiry input unit and restricting condition input to the restricting condition input unit by the user.

The search result storing unit 203 temporarily stores the search result returned from the searching server so that the user interface program 201 presents it to the user.

<Associative Search>

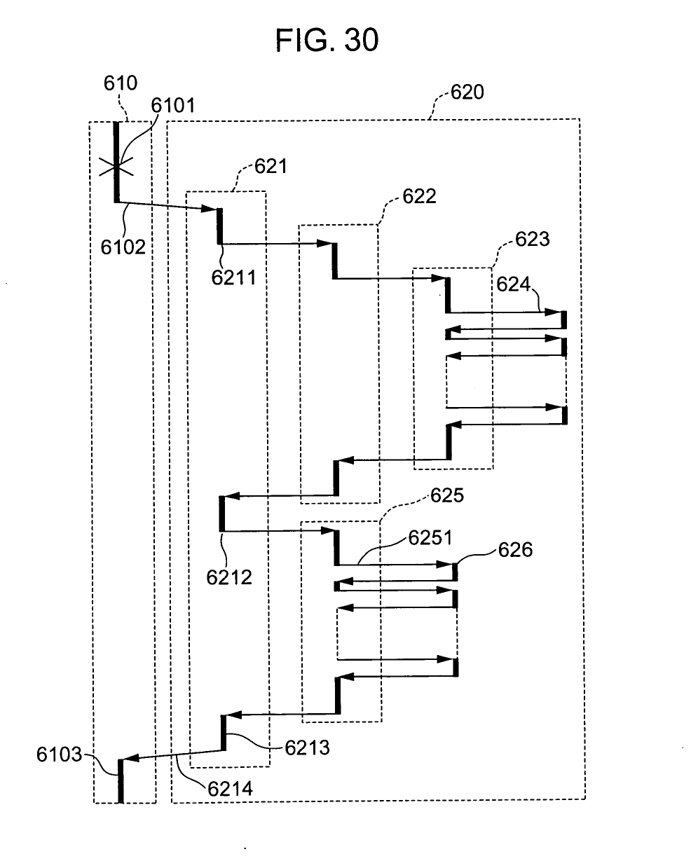

FIG. 29 shows an outline of a dependence relation of the procedures which are used in the searching server. A procedure 1 is a procedure at the top level of the associative search which is made by the searching server and the associative search is executed by calling the procedure 1. Procedures 2 and 5 are called from the procedure 1. A procedure 3 is called from the procedure 2, a procedure 4 is called from the procedure 3, and a procedure 6 is called from the procedure 5.

FIG. 30 shows an example of a situation of the calling and execution of those procedures upon execution of the associative search. In the diagram, an axis of ordinate indicates a time base. A section in a frame of reference numeral 610 denotes processes in the user interface and a section in a frame of reference numeral 620 denotes processes in the searching server. Further, a section in a frame of reference numeral 621 denotes processes of the procedure 1, a section in a frame of reference numeral 622 denotes processes of the procedure 2, a section in a frame of reference numeral 623 denotes processes of the procedure 3, a section in a frame of reference numeral 624 denotes processes of the procedure 4, and a section in a frame of reference numeral 625 denotes processes of the procedure 5, respectively.

When the search is started by using the user interface as a trigger (step 6101), the user interface 2 forms the search request and sends it to the searching server (step 6102). The searching server processes the request of the user interface by executing the procedure 1 (621) and returns a processing result to the user interface 2 (step 6103). Step 6103 shows a search result display. The execution of the procedure 1 (621) comprises three steps: calling of the procedure 2 (step 6211); calling of the procedure 3 (step 6212); and return of the search result to the user interface 2 (step 6213 relates to preparation and transmission of the search result return, step 6214 relates to return of the search result).

The procedure 2 (622) executes three steps comprising 1: a summary of the search request sent from the user by calling the procedure 3 is formed, 2: a search word list is formed, and 3: the summary word list and the search word list are combined. The creation of the summary word list is mainly performed by the procedure 3 (623). The procedure 3 executes three steps comprising 1: a list of the words contained in the document is formed every document in the document list, 2: a list obtained by collecting the same words among the elements of the word list is used as an argument and the procedure 4 is repetitively called, and 3: the contents of a summary word candidate holding means 1012 are outputted. In the procedure 4, on the basis of the list of words (all of them comprise the same word) sent from the procedure 3, importance of the word is calculated by using an importance calculating program 1011, and a calculation result is accumulated into a summary word candidate holding means as necessary (step 624). The list of words held in the summary word candidate holding means when the procedure 3 finishes the calling of the procedure 4 with respect to all of the words is the list of the summary words.

The procedure 5 (625) is a procedure for searching for related documents using the summary words formed in the procedure 2. Procedure 5 executes three steps comprising 1: a document list containing the word is formed every word in the summary word list, 2: a list obtained by collecting the same documents among the elements of the document list is used as an argument and the procedure 6 is repetitively called (step 6251), and 3: the contents of a search result candidate holding means 1015 are outputted. In the procedure 6 (626), on the basis of the list of documents (all of them comprise the same document) sent from the procedure 5, a similarity of the document to the search request (i.e. summary words) is calculated by using a similarity calculating program 1013, and further, whether the document satisfies the restricting conditions or not is examined by using a restricting condition examining program 1014 and an examination result is accumulated into a search result candidate holding program as necessary. The documents held in the search result candidate holding means 1015 when the procedure 5 (625) finishes the calling of the procedure 6 with respect to all articles is the search result.

The result is returned to the user interface (step 6214) and displayed as a search result by the user interface (step 6103). Each process will be described in detail hereinbelow.

The associative search is started by depressing the search start button 214 (FIG. 4) by using physical input means such as a mouse 932 or the like. As an event to start the associative search, besides the depression of the search start button 214, it is also possible to use a method of depressing a line feed key or a return key provided for the keyboard 931 (FIG. 1). When the depression of the search start button 214 or the key or the like is detected by the hardware and the operating system, such an event is transferred to an interface program and the interface program starts the associative search. When the associative search is started, first, the interface program collects information necessary for the associative search by the following procedure.

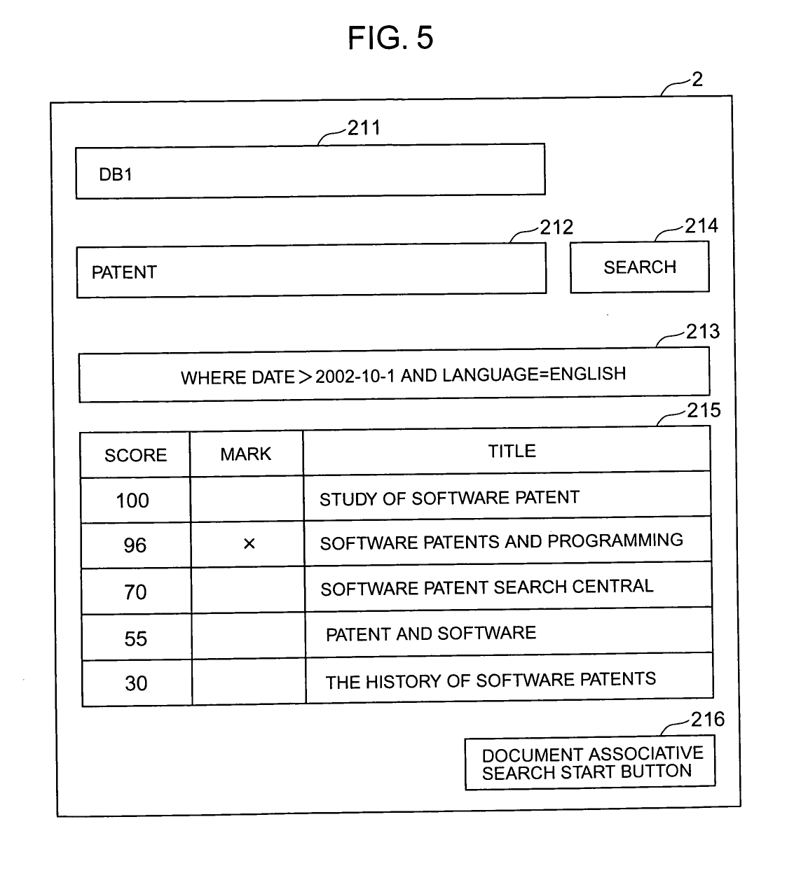

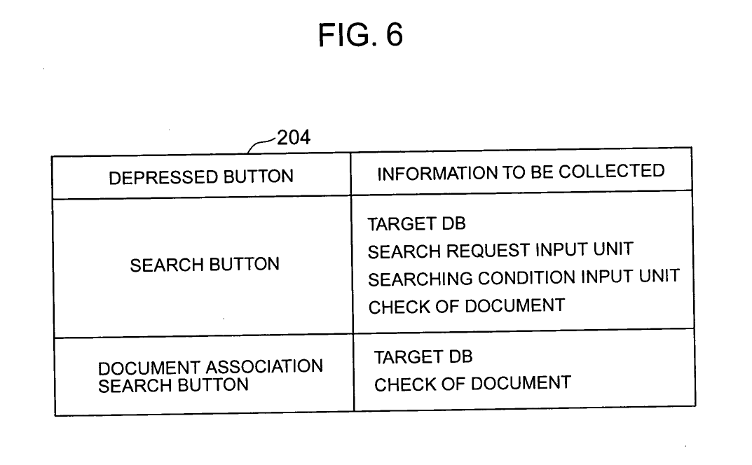

As information necessary for the associative search, there are: a database serving as a search target selected by the database selecting unit 211 (FIG. 4); the inquiry sentence or word (hereinafter, referred to as an inquiry sentence) inputted to the inquiry input unit 212; the restricting conditions to the search target inputted to the restricting condition input unit 213; and the documents marked (hereinafter, referred to as an associating source documents) in the search result display unit 215. The interface program stores those information into the search request storing unit. Like a case of making the associative search from the documents on the basis of the mark added to the document or the like, there is also a case where it is more preferable to make the associative search by using only a part of the foregoing information instead of using all of the information. In this case, only the necessary information has to be stored into the search request storing unit. That is, it is necessary to selectively collect the information necessary for the associative search. It can be realized by, for example, a method whereby by adding a document association search start button 216 to the user interface as shown in FIG. 5, a plurality of buttons serving as triggers to start the search are prepared and information to be collected is determined in accordance with the depressed button on the basis of a correspondence table 204 as shown in FIG. 6 which has been prepared. For example, in case of search start button, database serving as a search target, inquiring sentence, restriction condition, and marked documents are selected. In case of the document associative search start button, database . . . , and marked documents are collected.

When the information necessary for the associative search is collected, the interface program sends the collected information to the searching server. When the searching server 1 receives such information (hereinafter, referred to as a search request), it calculates the similarities (association calculation) from the inquiry sentence and the associating source documents with respect to each of the document which satisfies the restricting conditions among the documents in the designated target database and returns the documents of a high point among the calculated similarities to the interface program.

Those specific procedures are as follows.

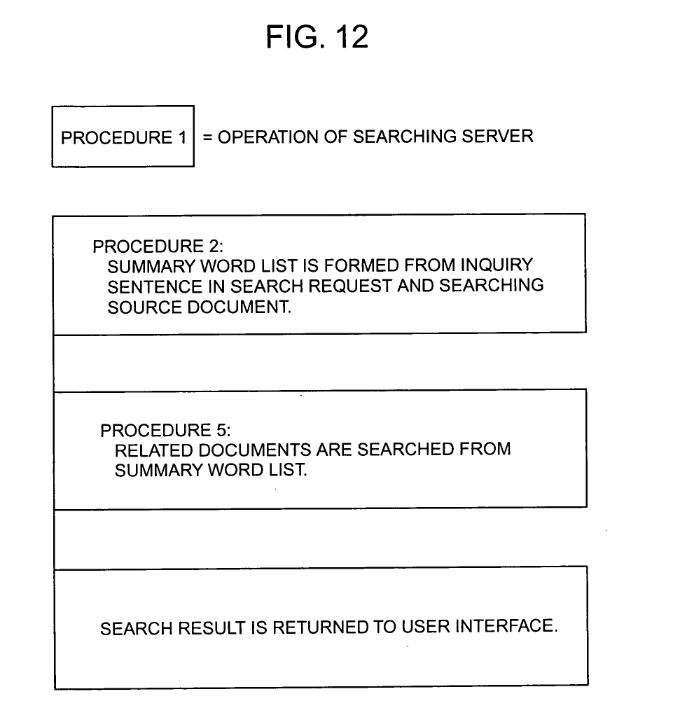

1. First, as shown in a procedure 1 in FIG. 12, the searching server specifies a target database existing in the search request and initializes an access to the target database so that the search can be made with respect to the target database after that.

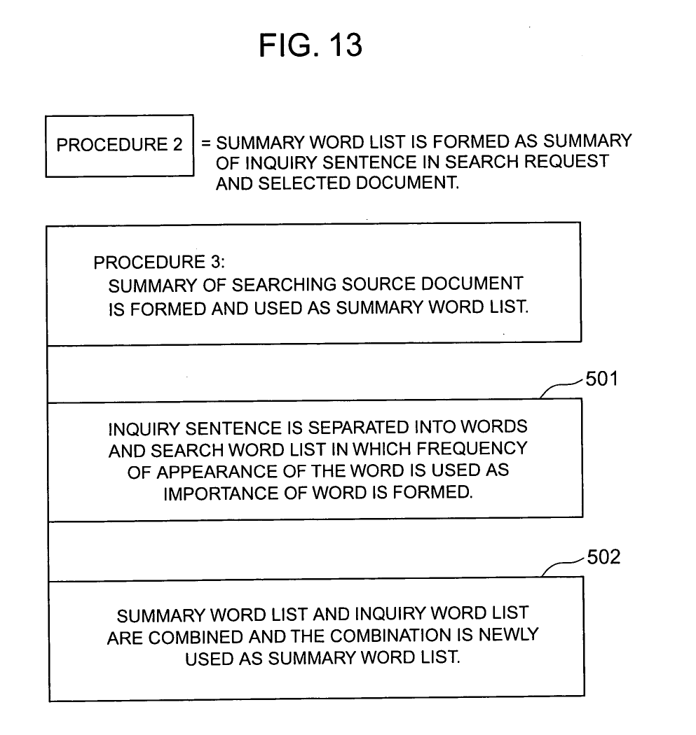

2. Subsequent to the procedure 1, as shown in FIG. 12, the searching server forms a summary word list from the inquiry sentence and the searching source document in the search request as a procedure 2. The procedure 2 will be specifically explained. First, as shown in FIG. 13, the inquiry sentence in the search request is separated into words and a list of the words is formed (step 501). Such a list is called a search word list. The operation to separate the inquiry sentence into the words can be executed by using the morpheme analyzing program 12 (FIG. 1). Specifically speaking, if the morpheme analyzing program is not activated, it is activated and a communication path with the morpheme analyzing program is established. After the communication path was established, a character train whose morpheme should be analyzed is sent via the communication path. Subsequently, a train of morphemes obtained by analyzing it is received via the communication path. After completion of the morpheme analysis, the communication path is closed as necessary. Finally, the morpheme analyzing program is stopped. In the above operation, the activation, stop, communication, or the like of the program can be easily executed by requesting it to the operating system. The morpheme analyzing program can be assembled as a part of the searching server program without being called as an external program. In such a case, it will be obviously understood that the communication which is made via the operating system becomes unnecessary and the data can be transmitted or received in the program.

3. Subsequently, as a procedure 3, the searching server summarizes the associating source documents and forms a list of the words representing the documents. Importance has been given as a real number to the word list every word. The searching server extracts only a predetermined proper number (m) of words in order of the importance and uses them. The list of the words representing the documents is hereinafter referred to as a summary word list.

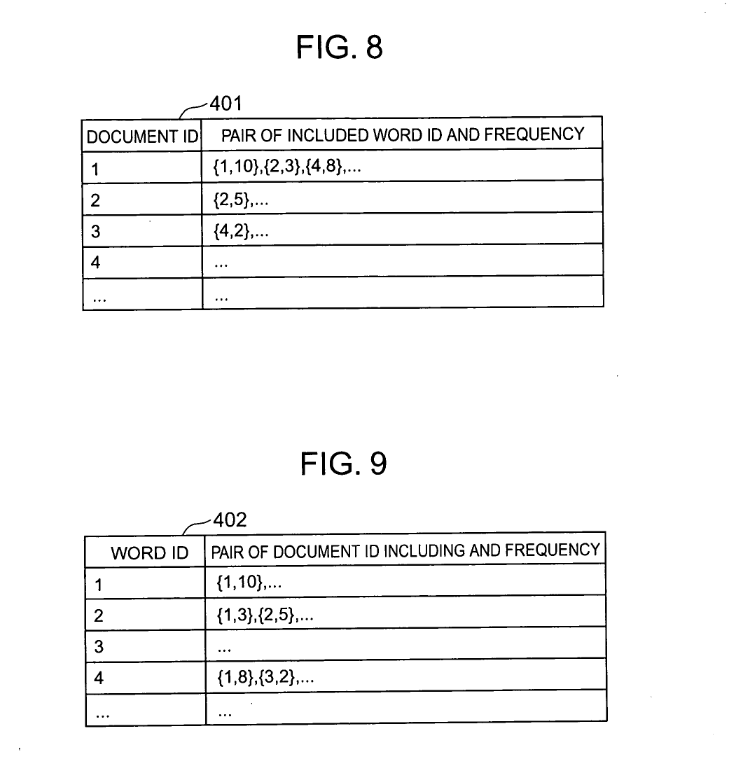

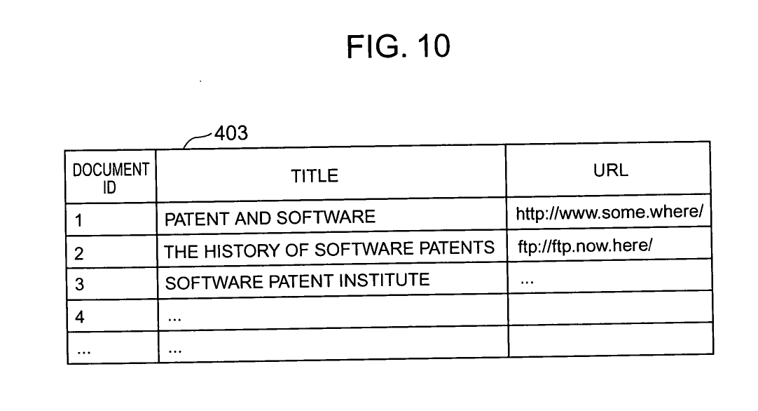

The data (document-word) 401 regarding the document DB shown in FIG. 7 is used to form the summary word list. As shown in FIG. 8, the word appearing in each document and its frequency have been recorded in the data (document-word) 401 regarding the document DB with respect to each document as mentioned above. FIG. 9 shows the data (word-document) 402 regarding the document DB shown in FIG. 7. FIG. 10 shows the data (meta data) 403 regarding the document DB.

First, the searching server obtains a list of the words with their frequencies appearing in each associating source document and its frequency with respect to all of the associating source documents by referring to the table of the data regarding the document DB. That is, the lists of the same number as that of the associating source documents are obtained. Importance of all of the words appearing in those lists are calculated and only the words of large importance are extracted as necessary, thereby obtaining a summary. It is proper to use a statistical method for the calculation of the importance of each word. For example, a scale such as well-known TF·IDF, SMART, or the like can be used. Naturally, as is also well known, even in the case of using a more advanced scale such as scale based on hypergeometric distribution, SMART, or the like, it is sufficient that a module for calculating the importance is simply made to correspond to a definition expression.

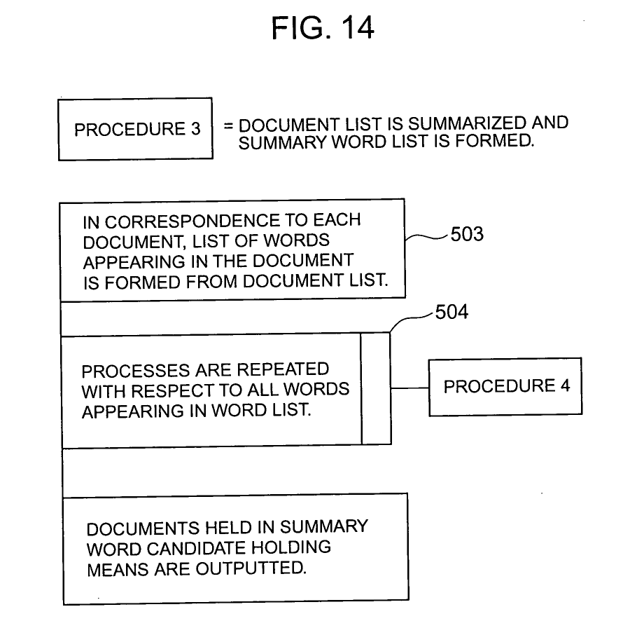

A specific procedure for forming the summary word list (procedure 3) is as follows. Explanation will be made hereinbelow with reference to FIG. 14. First, with respect to each document in the list of the associating source documents, a list of the words included in such a document is obtained with reference to the data (document-word) regarding the document DB (step 503). For all elements in each list, the document serving as a key of the list and the word are combined to one pair, that is, a set of the word, the document serving as a key, and the frequency is formed. Subsequently, all sets are collected to one list and the whole set is rearranged on the basis of the IDs of the words. A rearrangement result from the head of the list is sequentially checked and when the same word ID is arranged, those documents are collected. If an element appearing subsequently to the list has a different word ID, the documents collected until such an element are the documents regarding the same word. This word appears in one of the documents in the associating source document list and the documents collected until such an element are all documents including such a word among documents in the associating source document list. By repetitively executing such a process with respect to the whole list, a list of the words appearing in the document appearing in the associating source document list can be formed. Such a process relates to the alignment and combination of the data and has been studied a long time. Therefore, there are other various well-known methods and there is no problem even if those methods are used.

In next step 504, the processes are sequentially executed to the word list formed above. That is, the processes are repetitively executed with respect to all words appearing in the word list (step 504). In this process, only the element to which attention is paid is important and the whole list is unnecessary. Therefore, it will be obviously understood that by blending such a process to the list forming operation, the processes can be sequentially executed without forming the whole list first. This is because such a method can be realized merely by changing the procedures in such a manner that the above operation is interrupted when the element to be added to the word list is obtained during the above procedure, the operation (procedure 4) to be executed in the next step is executed to such an element, and after such an operation is finished, this list forming operation is restarted.

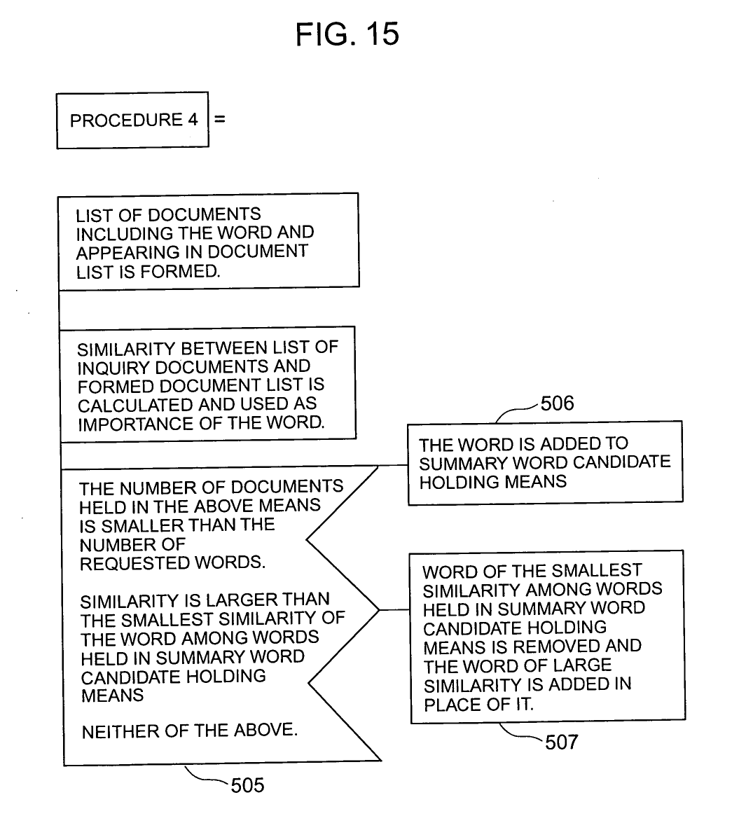

4. The procedure 4 will now be described with reference to FIG. 15. The search system applies the following procedures to each of the words appearing in the word list formed by the above procedures.

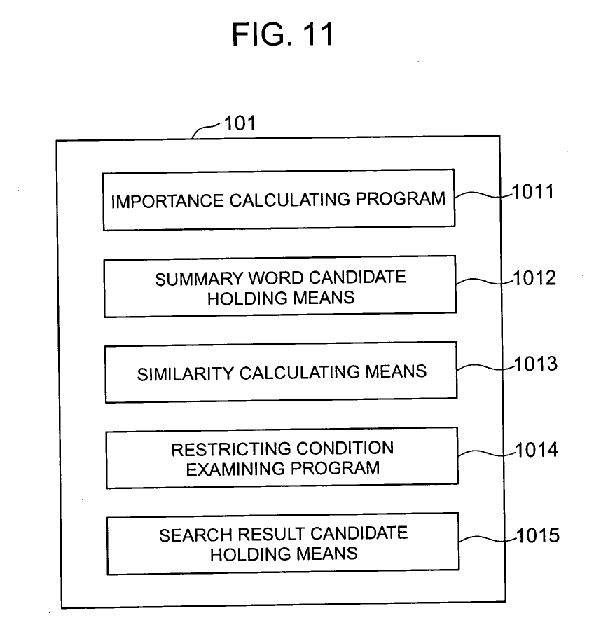

First, the search system calculates importance of a target word. For this purpose, a document vector which characterizes such a word and the list of all documents including such a word are extracted. Such extraction can be easily made by referring to the (word-document) data regarding the document DB. Upon calculation of a similarity between the document vector and a document list to be summarized, that is, importance in the summary list of the word, those two vectors are applied to a defined numerical expression in accordance with the similarity scale which is used and its value is merely calculated. It will be obvious that the calculation itself is easy irrespective of the simple scale such as TF·IDF or the like mentioned above or a complicated scale such as a scale based on SMART or the hypergeometric distribution or the like. Specifically speaking, the calculation is executed by the importance calculating program 1011 of the server shown in FIG. 11.

As already mentioned above, according to the invention, among the summaries, only the predetermined (m) number of summaries selected in order of the summary whose importance is large or all of them are used. In the case of using all of them, no problem occurs in particular and the word list formed in the above procedure becomes the summary as it is. In the case of using only (m) summaries, only (m) summaries of the large importance have to be extracted from the list. As a method for this purpose, a method whereby a perfect list is formed, the whole list is rearranged in order of the large importance, and (m) summaries from the head are extracted is one of the most obvious installing methods and no problem occurs even if such a method is used.

There is the following method (the whole operation of the procedures 3 and 4) as another method. The summary word candidate holding means 1012 of the searching server program 101 shown in FIG. 11 is used in this method.

First, the summary word candidate holding means is emptied. When importance of a new word is calculated, the search system selects the following three kinds of operations in accordance with conditions (step 505). First, if only less than (m) words exist in the summary word candidate holding means, those words are added to the search result candidate holding means (step 506). Secondly, if (m) words are included in the summary word candidate holding means and the importance of the word which is at present being processed is larger than the smallest importance among them, the word having the smallest importance is deleted from the summary word candidate holding means and, further, the word which is at present being processed is added to the summary word candidate holding means (step 507). Thirdly, if the word does not correspond to any of those two kinds of operations, the search system does not executes any operation to this word.

When the processes are completed with respect to all lists of the words, the (m) words have been stored in order of all the words in the word list their importance in the summary word candidate holding means or, if only (m) or less words exist in total, all of the words have been stored. It will be obvious from the above procedures in which the contents of summary word candidate holding means has sequentially been updated and it becomes the summary word list. When the documents are summarized, by handling the list of the search words consisting the inquiry sentence as another document, a summary word list of the checked documents and the search words can be also formed.

In this case, there is no need to execute combination with the list of the search words, which will be explained hereinbelow. The above method is especially useful in the case where, particularly, the advanced scale such as scale based on the hypergeometric distribution, SMART, or the like is used.

Subsequently, returning to the procedure 2 in FIG. 13, after the summary word list is calculated, the searching server subsequently combines the search word consisting the inquiry sentence with the summary word list (step 502). Naturally, in the case where only one of them is necessary in accordance with the searching conditions or if the list of the search words is handled as a summary document, the above operation is unnecessary. In the combining operation of the search word and the summary word list, first, adjustment of importance is made for each word. Although the value based on the scale used in the calculation of the importance has been added to each word in the summary word list, only the frequency is known for each search word. Therefore, for example, the value is adjusted so that the maximum value of the frequency added to the search word is equalized to the maximum value added to the words appearing in the summary word list. If the user wants to attach importance to either of them, it is possible to easily cope with such a situation by a method whereby after the adjustment, the value on the side to which the user wants to attach importance is multiplied by a proper constant which has previously been selected, or the like.

After completion of the adjustment of the importance, two lists are coupled and the words are rearranged in order of the IDs of the words. The rearrangement can be easily executed by using a well-known sorting algorithm. Although there is a possibility that overlapped words among the search words and the words in the summary word list appear in the rearranged list, since they are neighboring in the list, they can be easily detected merely by sequentially examining the list. With respect to the overlapped words, by adding the importance to them and updating the list as one word, a list without any overlapped word can be finally formed.

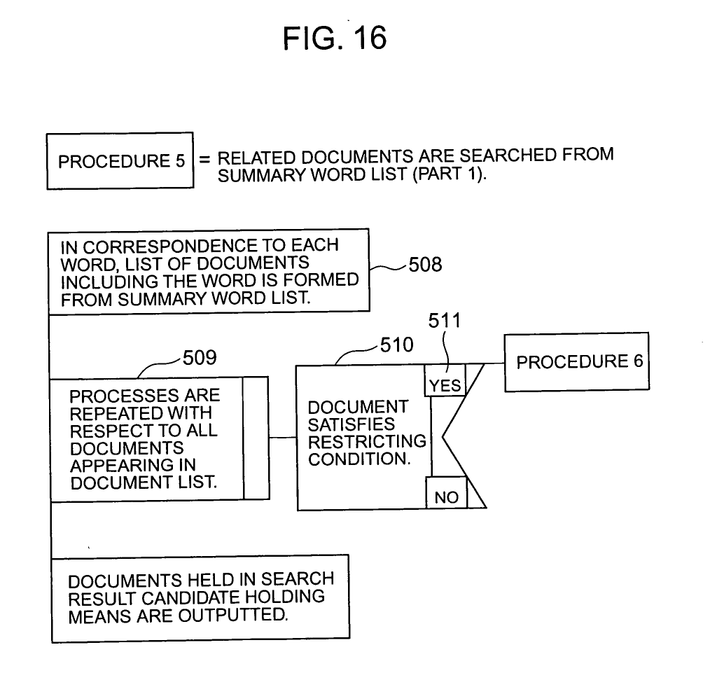

5. When the creation of the summary word list in the procedure 2 is completed as mentioned above, as shown in FIG. 12, the processing routine advances to a step of searching for the related documents from the summary word list in the procedure 5. The searching server regards the combined summary word list as a document and searches for the documents which are similar to such a document and satisfy the restricting conditions in the search request from the search target DB (procedure 5). Only the documents of the number requested from the document of the higher similarity among the searched documents are returned to the user interface. The above processes are executed by the following procedure as shown in FIG. 16.

The searching server forms a list of the documents including the words appearing in the summary word list. At this time, with respect to each document, among the words in the summary word list, a list of the words included in the document is also formed. In this procedure, the data (word-document) 402 regarding the document DB (FIG. 7) is used.

First, with respect to each word in the summary word list, a list of the documents including such a word is obtained with reference to the data (word-document) regarding the document DB (step 508). For all elements in each list, a pair is formed by the words serving as keys of the list, that is, a set of the document, the word serving as a key, and its frequency is formed. Subsequently, all sets are combined to one list and the whole list is rearranged on the basis of the IDs of the documents. On the basis of a rearrangement result, the sets are sequentially checked from the head in the list and they are collected while the same document ID is arranged. If the element appearing in next order in the list has a different document ID, the sets collected so far relate to the same document and a list comprising only the sets each having the words appearing in the document and also appearing in the summary word list as a pair is obtained, so that the object is accomplished. By repetitively executing the above processes with respect to the whole list, the list of the documents including at least one of the words appearing in the summary word list can be formed. Those processes relate to the alignment and combination of the data have widely been studied. There are other various well-known methods and no problem will occur even in the case of using those methods.

In next step 509, the processes can be sequentially executed to such a list of the document. However, in this operation, only the target element is important and the whole list is unnecessary. Therefore, naturally, by combining it with the operation to form the document list, the processes can be sequentially executed without forming the whole list first. This is because those processes can be realized merely by changing the procedure in such a manner that in the above procedure, the above list making operation is interrupted when an element to be added to the list is obtained, the operation to be executed in the next step is executed to this element, and after completion of this operation, the interrupted operation is restarted.

Subsequently, to each element in the list of the documents including the words in the summary word list, the searching server sequentially discriminate whether the document is set to the search result or not (step 509). First, whether the document satisfies the restricting condition present in the search inquiry or not is discriminated (step 510). In this discriminating step, the restricting condition examining program 1014 (FIG. 11) as a part of the searching server program is used. The restricting condition examining program executes the following operation in accordance with the type of restriction.

First, if it is proper to call an external procedure like a case where the restricting condition is a conditional clause of an SQL or the like, whether the restricting condition is satisfied or not is confirmed by calling an external DBMS (Database Management System) or the like. Although a specific procedure differs depending on the DBMS which is used and the operating system which is used as a platform, a standard method has been provided every combination of them. It will be obviously understood that it can be extremely easily realized by using the proper method in the system. If the restricting condition relates to the existence of the word like a case where a specific word under inquiry is indispensable, a case where a word which must not appear (a taboo word) has been designated, or the like, with respect to the document which is being processed, the list of the words appearing in the document can be easily extracted by referring to the data (document-word) regarding the document DB. Therefore, whether the specific word appears in the document or not can be also easily discriminated in accordance with the condition. If a plurality of conditions are designated as a conjunction, all of the conditions have to be satisfied. However, it can be realized by a method whereby the conditions are sequentially examined and if any one of them is not satisfied, it is determined that the conditions are not satisfied, and after all of the conditions are completely examined, it is determined that the conditions are satisfied. If a plurality of conditions are designated as a disjunction, it is sufficient that any one of them is satisfied. It can be realized by a method whereby the conditions are sequentially examined and if any one of them is satisfied at this point of time, it is determined that the conditions are satisfied, and when all of the conditions are completely examined, it is determined that the conditions are not satisfied. If disjunctions and conjunctions are combined, while the external condition is executed, it is sufficient that the one-stage inner portion is used as one condition and the process is executed. This is nothing but that the discriminating procedure is recursively applied. The fact that even if the two or more recursive stages exists, it can be processed by this method can be easily confirmed by a mathematical induction. Installation can be also extremely easily made by using a standard information engineering method.

When the condition discrimination is completed by the restricting condition examining program and the document which is being processed does not satisfy the condition present in the inquiry, this document cannot become the search result. Therefore, it is sufficient to merely ignore it and shift to the process of the next document.

If the document which is being processed satisfies the condition present in the inquiry, there is a possibility that this document becomes the search result (step 511).

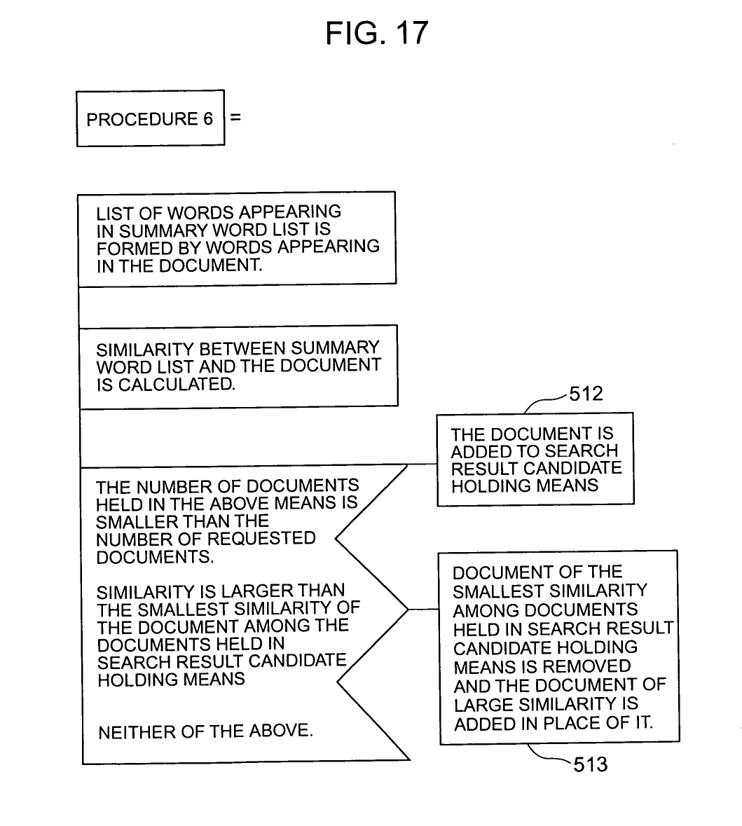

6. As mentioned above, when the document satisfies the restricting condition, a procedure 6 is executed as shown in FIG. 17. The search system calculates a similarity between the summary word list and this document. For this purpose, first, a word vector which characterizes the document is extracted. Such extraction can be easily performed by referring to the data (document-word) regarding the document DB. A calculation of a similarity between the word vector and the summary word list (that is, the similarity between the summary word list and this document) is equivalent to the operation in which those two vectors are applied to a numerical expression defined in accordance with the similarity scale which is used and a value is merely calculated. It will be obvious that the calculation itself is easy irrespective of the simple scale such as TF·IDF or the like mentioned above or the complicated scale such as a scale based on SMART or the hypergeometric distribution or the like. This calculation is executed by the similarity calculating program 1013 (FIG. 11).

The search system of the invention assigns a similarity to each of the documents which satisfy the conditions and returns the documents of the requested number (hereinafter, n) in order of the document of the large similarity or returns all of the documents. However, in a manner similar to the case where the summary word list is formed, it should be noted that whether a certain document exists in the upper (n) documents of the large similarity or not cannot be discriminated until the processes of all of the documents are finished. In the invention, therefore, the search result list is formed by the following method.

That is, the documents whose similarities lie within upper (n) similarities at the point of time when the list is processed up to a certain element are stored in the search result candidate holding means 1015. However, if the number of documents which satisfy the conditions among the documents processed so far is less than (n), all of them, that is, the documents less than (n) are held in the search result candidate holding means. It can be specifically realized by the following operation (procedures 5 and 6).

When a new document becomes a candidate of the result, the search system selects the following three kinds of operations in accordance with the conditions. First, if only the documents less than (n) exist in the search result candidate holding means, those documents are added to the search result candidate holding means (step 512). Secondly, if (n) documents are included in the search result candidate holding means and the similarity of the document which is being processed at present is larger than the smallest similarity among the (n) documents, the document having the smallest similarity is deleted from the search result candidate holding means and, further, the document which is being processed at present is added to the search result candidate holding means (step 513). Thirdly, if the document does not correspond to any of those two kinds of operations, the search system does not execute any operation to this document.

When the processes are completed with respect to all the documents in the document list, the (n) documents have been stored in order of the document which satisfies the conditions and whose similarity to the summary word list is large have been stored in the search result candidate holding means or, if there are only the documents less than (n) in total, all of the documents have been stored. It will be obvious from the foregoing procedure in which the documents in the search result candidate holding means have sequentially been updated and it becomes the search result. Naturally, like a method described when the summary word list is formed, it can be also realized by another method whereby a whole list is formed, it is rearranged in order of the document of the large similarity, and the upper (n) documents are extracted from the list. The list of the documents similar to the search request formed by the above procedure corresponds to the search result.

The search system returns the search result to the user interface via communicating means. In this instance, a title, URL, and the like of the document are also sent in association with the search result as necessary. They are necessary when the user interface displays the result or obtains the main body of the search result. The title, URL, and the like can be easily obtained by referring to the data (document meta data) regarding the document DB.

Naturally, the words used for the restricting conditions can be also used as keywords for the association search.

### Embodiment 2

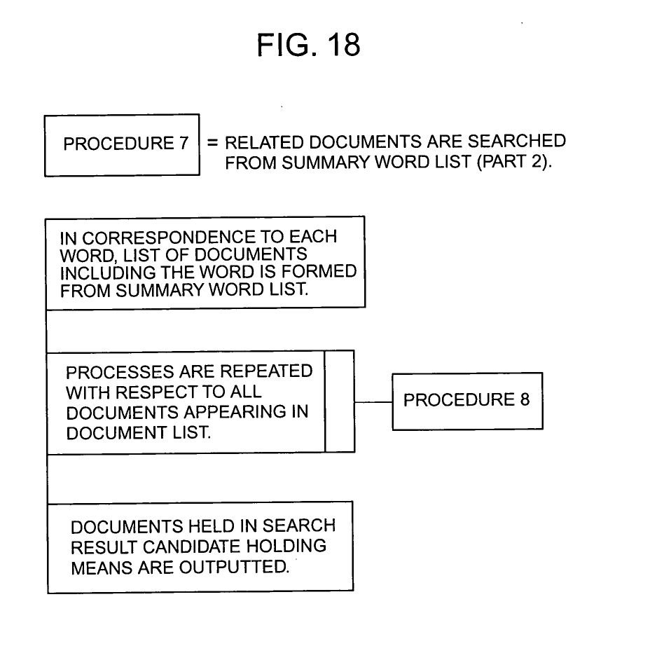

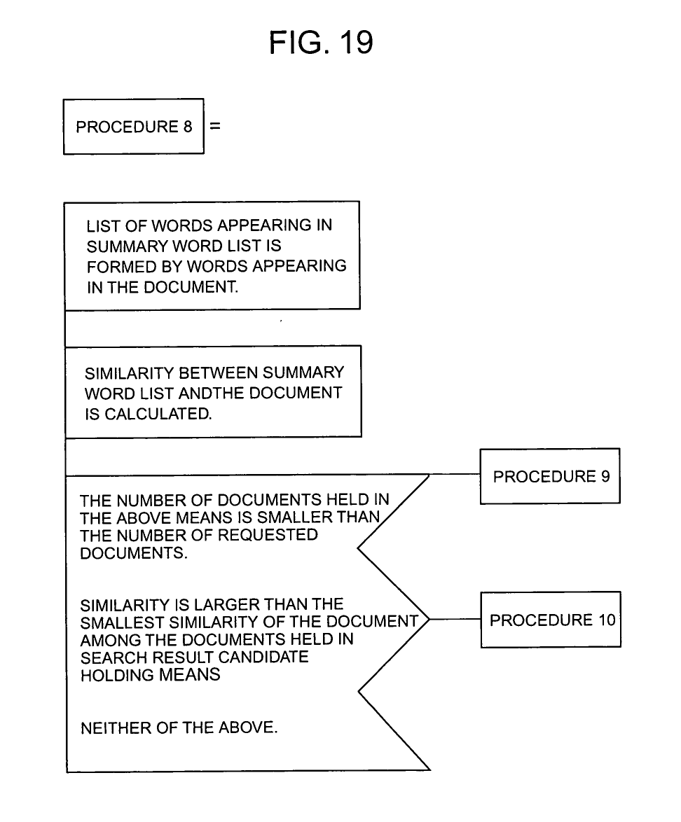

In the embodiment 1 mentioned above, in the procedure 5, the discrimination about the conditions is made first and the similarity is calculated with respect to the document which satisfies the conditions and the document is added to the search result candidate holding means. Installation in which the above processing order is reversed will be described in the embodiment 2 (FIGS. 18 and 19).

First, as shown in FIG. 18, in a procedure 7, in correspondence to each word, a list of the documents including such a word is formed from the summary word list and, subsequently, the processes are repeated with respect to all documents appearing in the document list. This procedure is similar to the procedure 5. As shown in FIG. 19, when the elements in the document list are sequentially processed, first, the similarity between the document which is being processed and the summary word list is calculated.

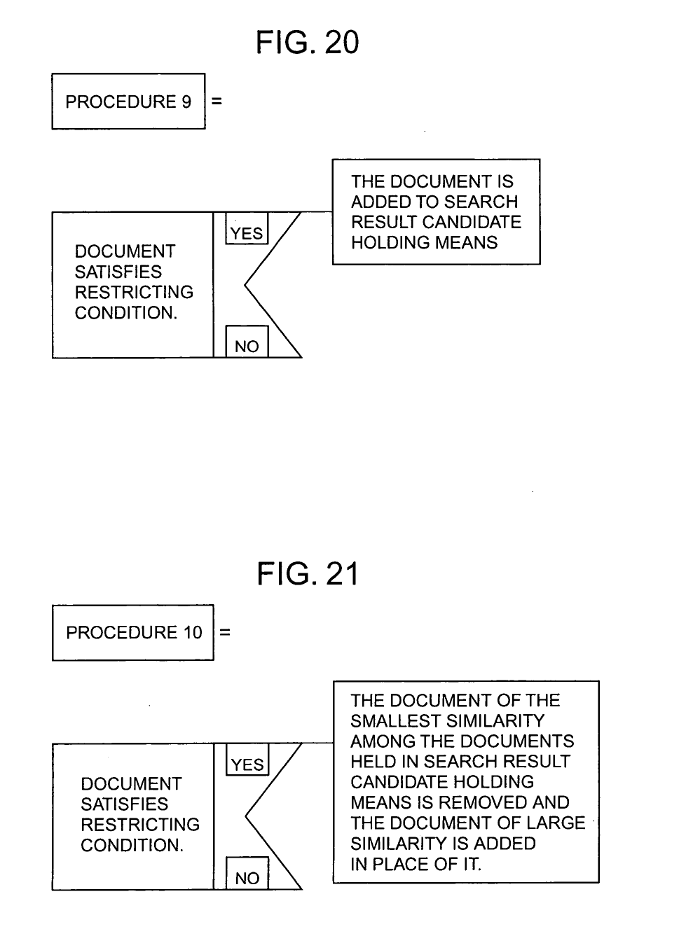

The search system selects the following three kinds of operations in accordance with the conditions. First, if only the documents less than (n) exist in the search result candidate holding means, whether the document which is being processed satisfies the conditions or not is discriminated. If it satisfies the conditions, this document is added to the search result candidate holding program (procedure 9, FIG. 20). Secondly, if (n) documents have been held in the search result candidate holding program and the calculated similarity is larger than the smallest similarity among the similarities of the (n) documents, whether the document which is being processed satisfies the conditions or not is discriminated. If it satisfies the conditions, the document having the smallest similarity is excluded from the search result candidate holding means and, subsequently, the document which is being processed is added to the search result candidate holding means (procedure 10, FIG. 21). Thirdly, if (n) documents have been held in the search result candidate holding means and the calculated similarity is not larger than the smallest similarity among the similarities of the (n) documents, no operation is executed to this document.

It will be obviously understood that the reason why the final contents of the search result candidate holding means formed as mentioned above are the same as those formed by the foregoing method is because a difference of the processes corresponds to the simple exchange of the order of the processes of the conjunction and a commutative law is satisfied in the Boolean algebra.

### Embodiment 3

Although the data (document-word) regarding the document DB used in the procedures 2 to 10 is based on the single table, this table can be also divided. Processes in the case where the table is divided will now be described with respect to a procedure for summarizing the associating source documents as an example. A procedure to search for the similar documents from the summary word list is almost the same as the procedure in which the roles of the document and the word of the procedure, which will be explained here, are exchanged and a difference between them is only the examination of the restricting conditions. Therefore, since the procedure to search for the similar documents from the summary word list by using the divided tables can be extremely easily realized with reference to the procedure, which will be explained here, its specific explanation is omitted here.

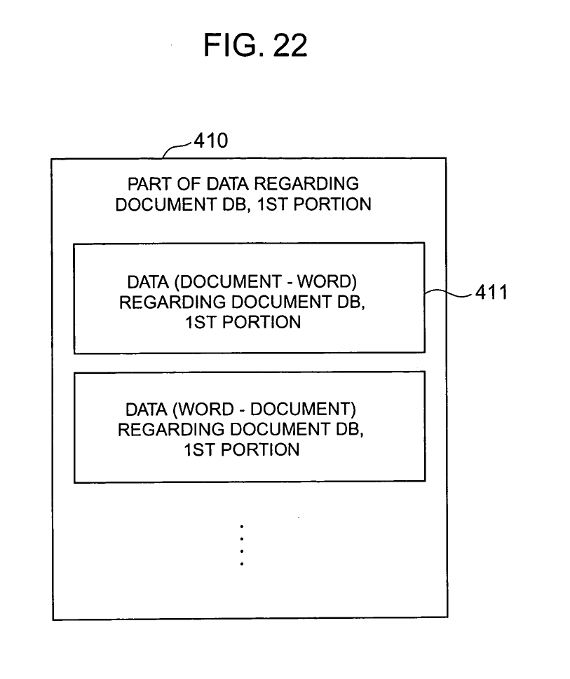

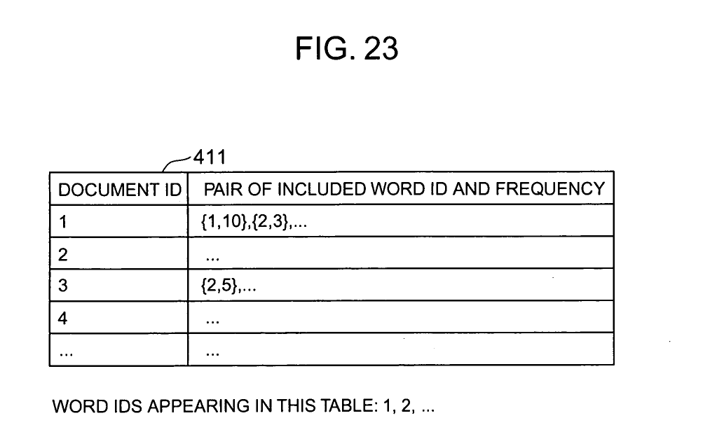

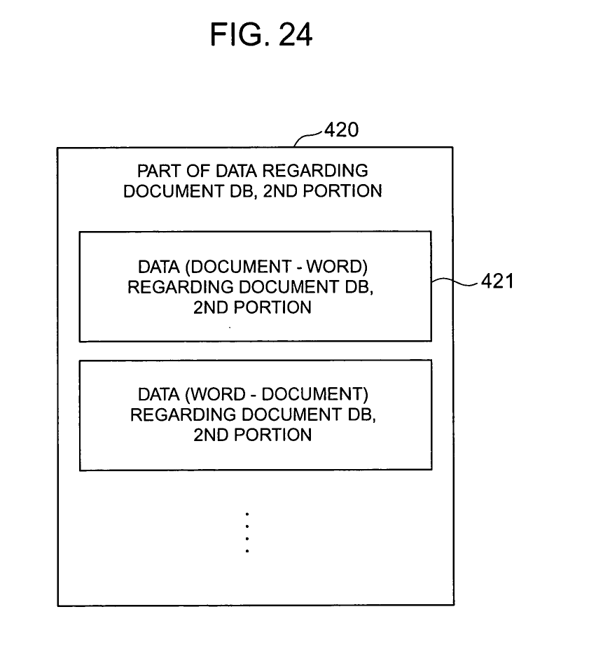

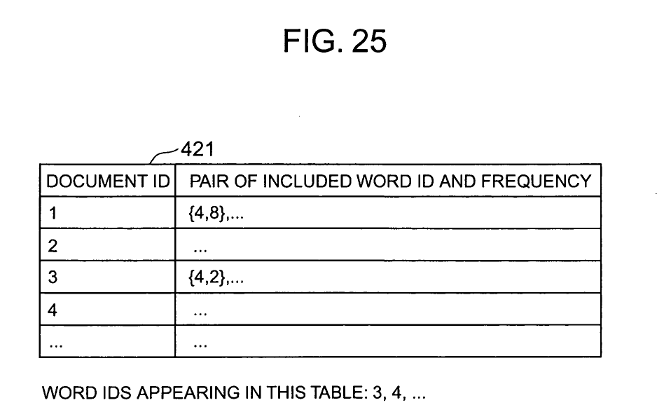

FIGS. 22 to 25 show an example in which the data (document-word) 410 and 420 regarding the document DB shown in FIG. 2 is divided into halves. As shown in FIGS. 22 and 24, upon division, a set of word IDs is divided into two sets which are mutually prime by a proper method, it is regarded that only the word ID included in each set appears in each document, and two data (document-word) 411 and 421 regarding the document DB corresponding to those sets are formed. In this example, only words whose word IDs are equal to 1, 2, . . . appear in the first portion 411 (FIG. 23) and only words whose word IDs are equal to 3, 4, . . . appear in the second portion 421 (FIG. 25). The set of the words corresponding to each portion is not specifically necessary but, so long as the divided tables can be formed without contradiction, either a mode in which it exists specifically or a mode in which it exists only virtually can be used. The expression “virtually” denotes a realizing method whereby when the table is divided, a proper procedure has been defined and the divided set of words is determined by this procedure. For example, by defining such a procedure that the word having the ID which can be exactly divided by 2 belongs to the first set and the word having the ID in which, when it is divided by 2, a remainder is equal to 1 belongs to the second set, the word sets can be defined without forming the word sets which were specifically divided.

Once the divided word sets can be formed, naturally, the word set which has only the words belonging to each set as elements and which is obtained by dividing the data (document-word) regarding the document DB can be easily formed. This is because if a procedure in which the non-divided table is once formed, a row in which only the elements appearing in the word set remain is formed with respect to each row of this table, and it is set to a corresponding row of a new table is executed twice every word set, two divided tables can be formed. Naturally, the divided tables can be also directly formed without forming the whole table. For this purpose, it is sufficient that the divided word sets are formed before the whole table is formed and, when each row of the whole table is formed, the elements are distributed to each of the divided tables. This method can be also easily installed.

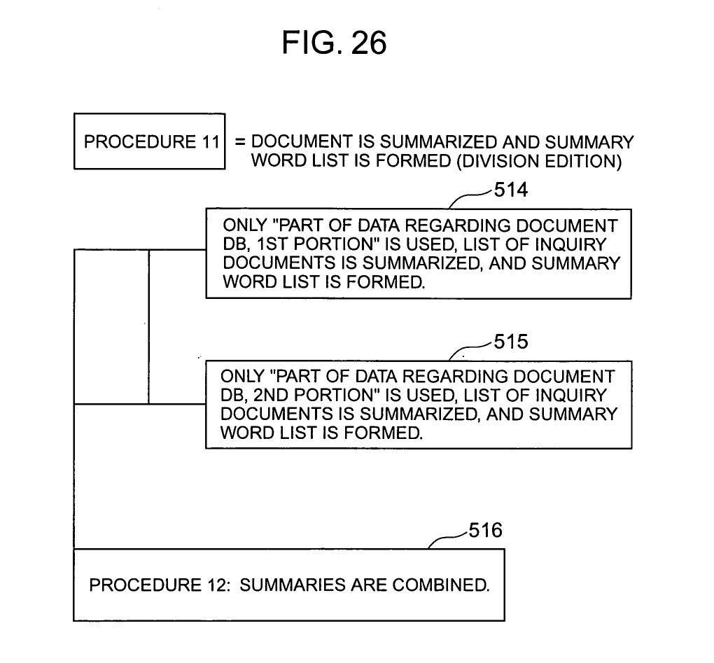

As shown in a procedure 11 (steps 514 and 515) shown in FIG. 26, the foregoing procedure for forming the summary word list is applied to each of the data (document-word) regarding the document DB divided as mentioned above in substantially the same manner as that in the case where the table is not divided (the reason why such a procedure can be applied will be explained hereinafter). Since the table is divided into halves in the case of this example, such a procedure is applied twice. The applying operations can be executed in parallel if the hardware or the operating system permits it. Assuming that the number of words which are used as summary words is equal to (m), the (m) summary words are extracted in a manner similar to the case where the table is not divided.

The reason why even in the case where the table is divided, the creation of the summary word list can be executed in a manner similar to the case where the table is not divided is as follows. Although it can be immediately derived from the method whereby the table has been divided, while the process is executed with respect to the word under the procedure which is summarizing, as a list of the documents including such a word, the same list as that formed by the method of forming it in an ordinary manner can be obtained. This nature is particularly important in the case of the procedure for searching for the similar documents from the summary words. In other words, owing to such a nature, even if any set of indispensable words is given as a conjunction as a restricting condition, the restricting conditions can be correctly examined. Further, the summary word lists formed as mentioned above are mutually prime according to their forming method. If the corresponding words exist in the summary word list formed by the ordinary manner, it is also guaranteed that values of their importance are the same.

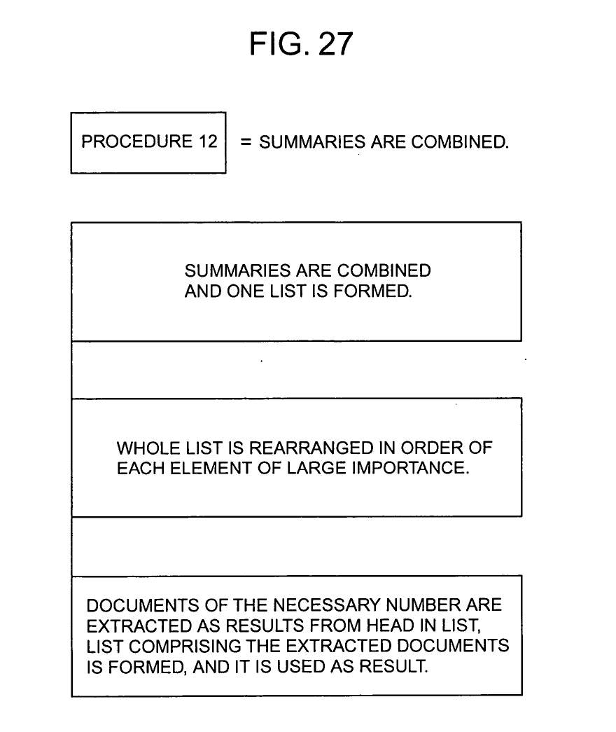

As shown in a procedure 12 (FIG. 27) (it is called from the procedure 11 (step 516) in FIG. 26), it will be also obviously understood from the foregoing reasons that the two formed summary word lists are combined with respect to those portions and the (m) words of the large importance are sequentially taken out, they coincide with those in the summary word list formed by the ordinary manner. The summary word lists can be formed by using the divided tables as mentioned above. Although it has been mentioned that the (m) results are necessary in the summarizing operation to each portion, the necessary number of results can be also set to a value, for example, (k) which is smaller than (m). In this case, naturally, in order to obtain the (m) words as a result of the combination, a value of (k) has to be set to m/2 or more. Even if it is equal to m/2 or more, however, when all of the (k) results are fully used in either of the two lists upon combination, although the words whose importance is smaller than that of the word having the smallest importance appear in the summary word list formed by the ordinary method, there is a possibility that they do not appear in the lists formed by this method (they are left off from the results, in other words, other words enter).

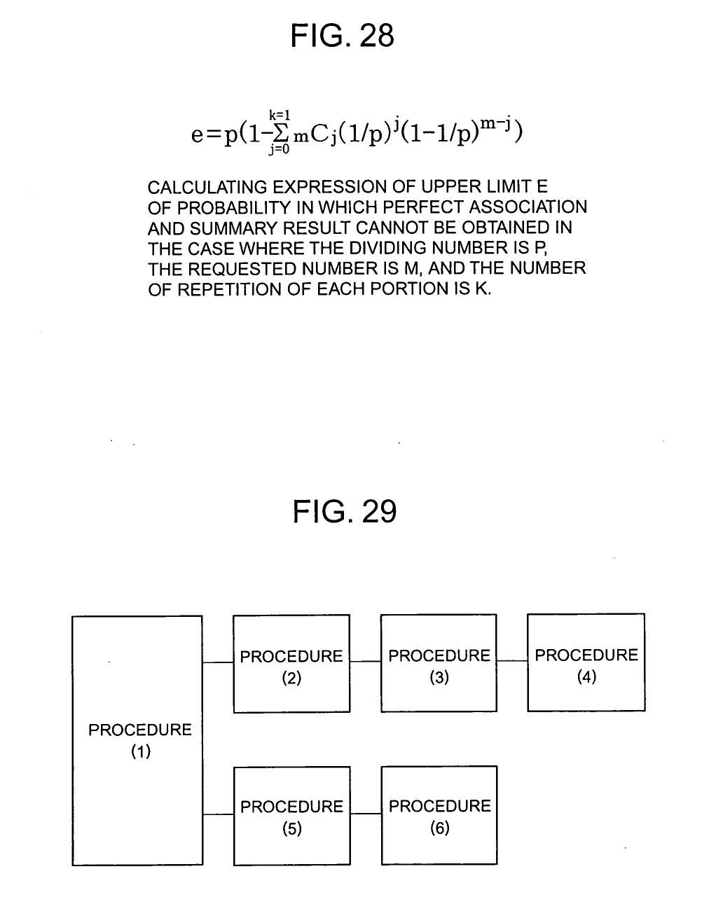

If the word set is divided sufficiently at random, a probability of occurrence of such a state can be calculated by using a calculating expression of a cumulative probability of binomial distribution (FIG. 28). By selecting a proper value (k), an arbitrary precision can be realized in a probability manner.

Although the table has been divided into halves in this example, generally, it can be also divided into an arbitrary number of parts. As a dividing method in this case, it is sufficient to merely increase the number of division in accordance with the method of dividing the table into halves and it can be similarly easily realized in a manner similar to the method of dividing the table into halves. The operation to form the summary word list in correspondence to each divided portion can be executed by a process which is operating on the hardware different from the searching server or a different process which is operating on the same hardware. At this time, in each process, at least an access to the divided table in which the summarization is made by each process has to be possible. Further, in the case of a document association, if the restricting conditions are set by an external program, an access to the external program has to be possible in a manner similar to the ordinary case. Such an access can be easily realized by properly making the setting of the hardware for storing the tables and the setting of the operating system and other DBMS upon operation. Further, the searching server has to be able to communicate with the process for summarizing each of the divided portions. It is assumed that the communication is made via the operating system. Since a method which is provided by the platform which is used can be used as a method of designating a specific process as a communication partner, no difficulty exists upon realization of it.

FIG. 2 shows a constructional example of a system in which a table is divided into halves and two sets of hardware are used. In this example, the searching server (main) 1041 plays a role for the communication with the user interface, a role for the summarization and document association to the first portion, and a role for the combination of the summary results of the respective portions, and the searching server (sub) 1041 plays a role for the summarization and document association to the second portion. Although not particularly shown, naturally, it is also possible to use another construction in which the number of searching servers (sub) is increased, each searching server (sub) plays the role for the summarization and document association, and the searching server (main) plays a role for the communication with the user interface and the role for the combination of the summary results of the respective portions. Even if the number of division is set to a value larger than 2, it is sufficient to increase the number of searching servers (sub) in accordance with the dividing number.

Although the case of using the words upon execution of the document association has been shown in any of the above examples, such means is not limited to the words but any means such as character n-gram, base sequence n-gram, part obtained by dividing an amino acid secondary structure into proper lengths, or the like can be used so long as it characterizes the document (characteristic prime). In this case, naturally, by replacing the morpheme analyzing program with a program corresponding to such a characteristic prime, it is possible to easily cope with those characteristic primes.

When the associative search is performed, the user can give the restricting conditions to the target document in addition to the document or sentence. The search system searches for the documents similar to the document or sentence which satisfies the restriction and functions as a key. The results are sequentially displayed from the result of the higher likelihood in a manner similar to the standard associative search. Thus, the association search to which the intention of the user is more accurately reflected can be made and the search can be made more efficiently.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An information searching method comprising the steps of:
inputting a search inquiry character train;
forming a summary by using said search inquiry character train and forming a summary word list;
inputting restricting condition for narrowing down search targets;
searching by using a document database on the basis of the similarity with said summary word list;
examining adaptability of a document whether or not satisfying said restricting condition; and
outputting search results adapted to said restricting condition among results of said similarity based search.

2. A method according to claim 1, wherein said restricting condition is an indispensable word which is indispensable for the search target or a taboo word, or a combination of indispensable words and taboo words.

3. A method according to claim 1, wherein said restricting condition is a search logical expression.

4. A method according to claim 1, wherein a word used for said restricting condition in positive contents are also used as a keyword for an associative search.

5. A method according to claim 1, wherein in said step of examining said adaptability, whether said restricting condition is satisfied or not is discriminated with respect to the search result searched in said associative searching step.

6. A method according to claim 1, wherein in said searching step, a document which satisfies said restricting condition is searched from said document database and its adaptability is examined and, thereafter, a similarity between the document which satisfies the adaptability and said summary word list is calculated, then searching is done on the basis of the similarity.

7. A method according to claim 1, wherein in said step of forming said summary word list, said summary word list is formed from said search inquiry character train and selected documents.

8. An information search system comprising:
an input frame for inputting a search inquiry character train;
a frame for inputting restricting condition for narrowing down search targets;
means for forming a summary by using said search inquiry character train and forming a summary word list;
a search button for searching by using a document database of an information searching apparatus on the basis of said summary word list, said search button instructing said information searching apparatus to search in accordance with depression of said search button; and
a search result display frame which receives from said information searching apparatus a search result searched by using said document database and said restricting condition and display said search result.

9. A system according to claim 8, wherein the frame for displaying the search result searched by using said document database and the frame for inputting said restricting condition are displayed in parallel onto a same display screen.

10. A searching server for searching for information, comprising:
importance calculating means for calculating importance of each word among words appearing in a document set on the basis of the frequency of each word in the document set and in said document database;
summary word candidate holding means for holding the words, as candidates, of the high importance calculated by said importance calculating means;
a summary word list which is formed as a summary of said search inquiry character train and selected documents being formed by said importance calculating means and said summary word candidate holding means;
similarity calculating means for calculating a similarity between said summary word list and a document stored in a document database;
restricting condition examining means for examining whether a document in said document database is adapted to a given restricting condition for narrowing down search targets or not; and
search result candidate holding means for holding results searched from said similarity calculating means and said restricting condition examining means.
